(19) United States
(12) Patent Application Publication
(10) Pub. No.: US 2023/0316525 A1
(43) Pub. Date: Oct. 5, 2023

(54) DEEP LEARNING-DERIVED MYOCARDIAL STRAIN

(71) Applicant: CEDARS-SINAI MEDICAL CENTER, Los Angeles, CA (US)

(72) Inventors: David Ouyang, Los Angeles, CA (US); Susan Cheng, Los Angeles, CA (US); John Theurer, Los Angeles, CA (US)

(73) Assignee: CEDARS-SINAI MEDICAL CENTER, Los Angeles, CA (US)

(21) Appl. No.: 18/191,745

(22) Filed: Mar. 28, 2023

Related U.S. Application Data
(60) Provisional application No. 63/325,807, filed on Mar. 31, 2022.

(51) Int. Cl. G06T 7/00; G06T 7/11; G06T 7/60; G06T 7/149

(52) U.S. Cl. CPC G06T 7/0014; G06T 7/11; G06T 7/60; G06T 7/149; G06T 2207/10016; G06T 2207/10132; G06T 2207/20081; G06T 2207/20084; G06T 2207/30048

(57) ABSTRACT

Disclosed herein are systems and methods for evaluating cardiac structural health condition based echocardiogram signals. In one example, a myocardial strain is determined based on segmented ventricles in a plurality of echocardiograms. In some examples, the ventricular segmentation is performed using a segmentation model based on a deep-learning approach.

### CROSS-REFERENCE TO RELATED APPLICATIONS

This application claims priority to and the benefit of U.S. Provisional Patent Application No. 63/325,807, filed Mar. 31, 2022, which is hereby incorporated by reference herein in its entirety.

### TECHNICAL FIELD

The present invention relates to myocardial strain measurements from echocardiograms.

### BACKGROUND

The following description includes information that may be useful in understanding the present invention. It is not an admission that any of the information provided herein is prior art or relevant to the presently claimed invention, or that any publication specifically or implicitly referenced is prior art.

Myocardial strain can be used to identify subtle signatures of cardiac dysfunction. It has specific applications in longitudinal monitoring of cardiotoxic therapies as well as diagnosis of cardiomyopathies. Even compared to classic measures such as left ventricular (LV) ejection fraction, longitudinal strain has incremental benefits for prediction of cardiovascular outcomes. Strain is formally defined as the change in the length (L) of a tissue relative the initial diastolic length (L₀): Strain=(L−L₀)/L₀. However, there are multiple implementations of strain calculation which vary across imaging modalities and vendors. Measurements of the length of each segment can significantly vary across vendors and significantly impact downstream assessment of strain as it is difficult to compare strain values across different vendors. Within echocardiography, the use of speckle tracking is the primary method of obtaining quantitative global longitudinal strain (GLS). The application of this method requires significant experience, and still exhibits significant inter- and intra-vendor variability due to proprietary methods of performing speckle tracking and inherent limitations of the technique, which limit the ability to estimate quality of assessment. Accordingly, there is a need for more accurate, reliable, and faster measurement of myocardial strain.

### SUMMARY

Methods and systems are provided to address at least some of the above-mentioned disadvantages. Further, the inventors have recognized that deep learning may be used to automate myocardial strain measurements from echocardiogram. Accordingly, in various implementations, systems and methods are provided for automatically measuring myocardial strain from echocardiograms. In one example, a method for quantifying LV global longitudinal strain (GLS) based on a deep learning pipeline is provided that automatically generates consistent and robust strain measurements. The systems and methods described herein perform consistently across multiple cohorts while also delivering results in a fraction of the time required for human assessment.

In one example, a deep learning strain (DLS) model takes blood pool semantic segmentation results from a deep learning segmentation network (alternatively referred to herein as EchoNet-Dynamic network) and derives longitudinal strain from a frame-by-frame change in left ventricle endocardial length. The DLS model was developed from 7,465 echocardiogram videos, including preprocessing steps to determine the change in endocardial length from systole to diastole. DLS was evaluated on a large external retrospective clinical dataset with global longitudinal strain measurements and prospectively compared with within-patient acquisition of manual measures by two experienced sonographers and two separate vendor speckle-tracking methods on different machines.

In one example, a method for determining myocardial strain comprises: acquiring an echocardiogram video; inputting the echocardiogram video into left ventricular segmentation model to obtain a blood pool segmentation output; and processing the blood pool segmentation via a deep learning strain model to determine an average cardiac strain in the echocardiogram video; wherein the segmentation model is trained on a plurality of echocardiograms to identify LV blood pool and wherein the deep learning strain model is trained to measure a length of LV in each frame, calculate a per beat strain, and/or calculate the average cardiac strain.

In this way, by leveraging LV measurements across multiple heart beats, the deep learning model can more accurately identify subtle changes in global length strain. As a result, reproducible and more accurate measurements of myocardial strain are obtained.

The above advantages and other advantages and features of the present description will be readily apparent from the following Detailed Description when taken alone or in connection with the accompanying drawings. It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

The accompanying drawings, which are incorporated in and constitute a part of this specification, exemplify the embodiments of the present invention and, together with the description, serve to explain and illustrate principles of the invention. The drawings are intended to illustrate major features of the exemplary embodiments in a diagrammatic manner. The drawings are not intended to depict every feature of actual embodiments nor relative dimensions of the depicted elements, and are not drawn to scale.

FIG. 1 is a schematic diagram illustrating an echocardiogram processing system for myocardial strain prediction, according to an embodiment of the description.

FIG. 2 is a schematic diagram illustrating an architecture of a convolutional neural network model for segmentation of LV and blood pool, which can be implemented in the echocardiogram processing system of FIG. 1, according to an embodiment of the disclosure;

FIGS. 3A, 3B, and 3C show example echocardiogram images including blood pool segmentation, bounding box identification for contour identification, and dilation respectively, according to an embodiment of the disclosure;

FIGS. 3D and 3E show example echocardiogram images including total border length outline for strain measurement, according to an embodiment of the disclosure;

FIG. 3F shows a graph depicting change in length over time with a smoothing filter, according to an embodiment of the disclosure;

FIGS. 4A and 4B show an example comparison of 3D echocardiography-based global longitudinal strain and deep learning-derived strain by Bland Altman and Correlation Plots. Deep learning strain was on average greater by 2.31%, Limits of Agreement of −6.01 to 10.64%. DLS: Deep learning strain; GLS: Global longitudinal strain. FIG. 4B shows model variation compared to human variation in annotation. Boxplot represents the median as a thick line, 25th and 75th percentiles as upper and lower bounds of the box, and individual points for instances greater than 1.5 times the interquartile range from the median;

FIG. 5 shows an intraclass correlation coefficient with 95% confidence interval by subjective quality score of the image (lower Quality Score is worse);

FIG. 6 is a graph showing comparison of different inter-reader methodologies for strain measurement in prospective cohort (GE: General Electric; DLS: Deep Learning Strain); and

FIG. 7 is a high-level flow chart showing an example method for performing myocardial strain measurement, according to an embodiment of the disclosure;

In the drawings, the same reference numbers and any acronyms identify elements or acts with the same or similar structure or functionality for ease of understanding and convenience. To easily identify the discussion of any particular element or act, the most significant digit or digits in a reference number refer to the Figure number in which that element is first introduced.

### DETAILED DESCRIPTION

Unless defined otherwise, technical and scientific terms used herein have the same meaning as commonly understood by one of ordinary skill in the art to which this invention belongs. Szycher's Dictionary of Medical Devices CRC Press, 1995, may provide useful guidance to many of the terms and phrases used herein. One skilled in the art will recognize many methods and materials similar or equivalent to those described herein, which could be used in the practice of the present invention. Indeed, the present invention is in no way limited to the methods and materials specifically described.

In some embodiments, properties such as dimensions, shapes, relative positions, and so forth, used to describe and claim certain embodiments of the invention are to be understood as being modified by the term “about.”

Various examples of the invention will now be described. The following description provides specific details for a thorough understanding and enabling description of these examples. One skilled in the relevant art will understand, however, that the invention may be practiced without many of these details. Likewise, one skilled in the relevant art will also understand that the invention can include many other obvious features not described in detail herein. Additionally, some well-known structures or functions may not be shown or described in detail below, so as to avoid unnecessarily obscuring the relevant description.

The terminology used below is to be interpreted in its broadest reasonable manner, even though it is being used in conjunction with a detailed description of certain specific examples of the invention. Indeed, certain terms may even be emphasized below; however, any terminology intended to be interpreted in any restricted manner will be overtly and specifically defined as such in this Detailed Description section.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations may be depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Disclosed herein are methods and systems for performing deep learning-based strain analysis. The method allows for beat-by-beat assessment of strain. The results demonstrate that there is moderate beat-to-beat variation in strain within a single acquisition, suggesting a lower bound in the precision of strain. The reference range of different strain methods depends on each commercially available machine and its strain analysis package, which can be limiting given the black-box nature of those software solutions. The deep learning strain algorithm described herein produces comparable strain values within the reference range suggested by professional societies for normal patients and is fully automated, allowing for adaptation, iterative improvement, and easy establishment of normal ranges using local data. Further, the DLS methodology has enhanced reproducibility, less variance between vendors, and has less dependence on image quality, and may enable better comparison with CMR feature-tracking measurements.

A technical advantage of the DLS model described herein is improvement in speed, reproducibility, and accuracy in myocardial strain measurement. In clinical practice, speckle-tracing algorithms often do not appropriately track the motion of the LV. The direct measurement and identification of the endocardial contour is both easily understandable and visually assessable for sources of error. The method for strain measurement using the DLS model enables rapid retrospective batch analysis of echocardiographic images, which may have applications in both the research and clinical workflow while eliminating human-based measurement variance. Additionally, this pipeline could also be adapted to other semantic segmentation models, allowing generalization to calculating right ventricular as well as atrial strain.

In this way, a deep-learning derived strain measurement is provided based on a deep learning derived endocardial contour. The results, described further below, show that this measurement can be performed reliably with low variance, and within the range of standard measurements. The DLS method is rapid, consistent, understandable, vendor-agnostic, and robust across a wide range of imaging qualities. As a result, the DLS model for myocardial strain measurement described herein provide significant improvement in cardiac health evaluation, which in turn enables improved patient outcome.

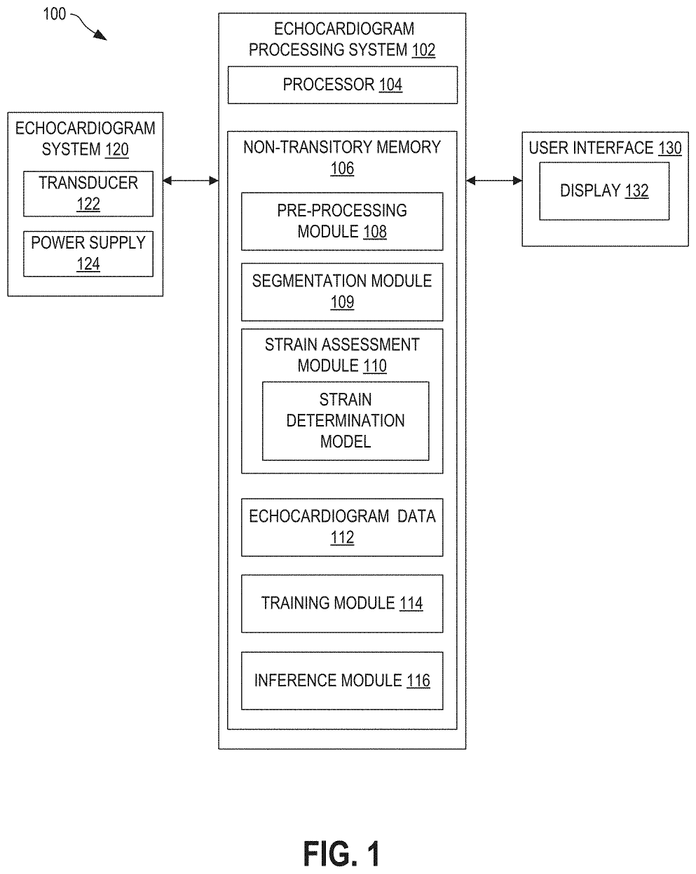

Referring to FIG. 1, an echocardiogram processing system 100 is shown, in accordance with an exemplary embodiment. In some embodiments, as shown, the echocardiogram processing system 100 is communicatively coupled to an echocardiogram acquisition system 120 comprising echocardiogram transducers 122. The transducers may be ultrasound transducers. The echocardiogram system 120 may further include a power supply 124 to provide electrical power to the transducers 122. Further, echocardiogram data, acquired via the echocardiogram signals, may be processed by an integrated processing unit and subsequently transmitted (via a wired and/or a wireless connection) to the echocardiogram processing system 100 for cardiac structure evaluation, including myocardial strain evaluation. In some examples, the echocardiogram data may be wirelessly transmitted to the integrated processing unit and/or the echocardiogram processing system communicatively coupled to the echocardiogram acquisition system 100. In one example, the system 120 may be a clinical grade echocardiogram system. In another example, the system 120 may be configured as a mobile ultrasound system.

In some embodiments, the echocardiogram processing system 100 is implemented using a device (e.g., edge device, server, etc.) that is communicably coupled to the echocardiogram system 120 via wired and/or wireless connections. In some embodiments, the echocardiogram processing system 100 is implemented using a separate device (e.g., a workstation) which can acquire echocardiogram data from the echocardiogram system 120 or from a storage device which stores the echocardiogram data acquired by the echocardiogram acquisition system 120.

The echocardiogram processing system 100 may comprise at least one processor 104, and a user interface 130 which may include a user input device (not shown), and a display device 132. User input device may comprise one or more of a touchscreen, a keyboard, a mouse, a trackpad, a motion sensing camera, or other device configured to enable a user to interact with and manipulate data within the echocardiogram processing system 100.

The at least one processor 104 is configured to execute machine readable instructions stored in non-transitory memory 106. The processor 104 may be single core or multi-core, and the programs executed thereon may be configured for parallel or distributed processing. In some embodiments, the processor 104 may optionally include individual components that are distributed throughout two or more devices, which may be remotely located and/or configured for coordinated processing. In some embodiments, one or more aspects of the processor 104 may be virtualized and executed by remotely-accessible networked computing devices configured in a cloud computing configuration. According to other embodiments, the processor 104 may include other electronic components capable of carrying out processing functions, such as a digital signal processor, a field-programmable gate array (FPGA), or a graphic board. According to other embodiments, the processor 104 may include multiple electronic components capable of carrying out processing functions. For example, the processor 104 may include two or more electronic components selected from a list of electronic components including: a central processor, a digital signal processor, a field-programmable gate array, and a graphic board.

In still further embodiments the processor 104 may be configured as a graphical processing unit (GPU) including parallel computing architecture and parallel processing capabilities. However, it will be appreciated that a trained neural network model as described herein may be implemented in a processor that does not have GPU processing capabilities.

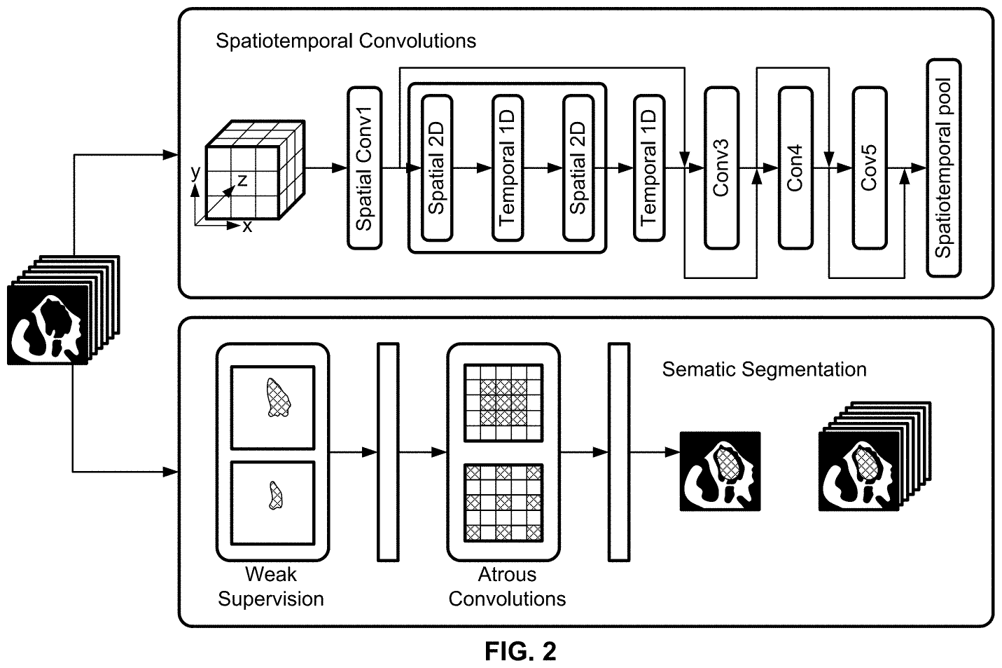

Non-transitory memory 106 may store a pre-processing module 108, a segmentation module 109, a strain assessment module 110, and echocardiogram data 112. The segmentation module 109 may include a semantic segmentation model comprising a plurality convolutional layers. An example semantic segmentation model is shown at FIG. 2. Details of the semantic segmentation model for ventricular segmentation is described by Ouyang, D., He, B., Ghorbani, A. et al. in “Video-based AI for beat-to-beat assessment of cardiac function” published in Nature 580, 252-256 (2020), the content of which is incorporated by reference herein in its entirety. The module 109 may further include instructions for implementing the segmentation model to receive an echocardiogram video data of a patient acquired and output a corresponding left ventricular segmentation and/or blood pool segmentation. Further, the module 109 may include trained and/or untrained neural networks and may further include various data, or metadata pertaining to the one or more neural networks stored therein.

The strain assessment module 110 may include a strain determination model including instructions for measuring a myocardial strain calculated as the mean change in length in the endocardial border within an echocardiogram video clip. The module 110 may further include instructions for implementing the strain determination model to receive the segmented video data of the patient acquired and output change in length over time in the video clip.

Non-transitory memory 106 may further store training module 114, which comprises instructions for training one or more neural network models stored in the module 110. Training module 114 may include instructions that, when executed by processor 104, cause echocardiogram processing system 100 to train one or more neural network models with corresponding training data sets, discussed in more detail below. In some embodiments, training module 114 includes instructions for implementing one or more gradient descent algorithms, applying one or more loss functions, and/or training routines, for use in adjusting parameters of one or more neural network models of the module 110.

Non-transitory memory 106 also stores an inference module 116 that comprises instructions for validating and testing new data with the trained neural network model. Non-transitory memory 106 further stores echocardiogram data 112. In some embodiments, echocardiogram data 112 may include a plurality of training sets, each comprising a plurality of echocardiograms.

In some embodiments, the non-transitory memory 106 may include components disposed at two or more devices, which may be remotely located and/or configured for coordinated processing. In some embodiments, one or more aspects of the non-transitory memory 106 may include remotely-accessible networked storage devices configured in a cloud computing configuration.

Display 132 may include one or more display devices utilizing virtually any type of technology. In some embodiments, display device 132 may comprise a computer monitor, and may display unprocessed and processed echocardiogram frames. Display device 132 may be combined with processor 104, non-transitory memory 106, and/or user input device in a shared enclosure, or may be peripheral display devices and may comprise a monitor, touchscreen, projector, or other display device known in the art, which may enable a user to view echocardiogram frames, and/or interact with various data stored in non-transitory memory 106.

It should be understood that echocardiogram processing system 100 shown in FIG. 1 is for illustration, not for limitation. Another appropriate image processing system may include more, fewer, or different components.

The echocardiogram processing system 100 may be used to train and deploy a neural network model, such as an example neural network model discussed below at FIG. 2.

### Neural Network Architecture.

FIG. 2 illustrates a high-level block diagram of a neural network model 200 that may be implemented for identifying segmenting left ventricle. The neural network model 200 comprises a first neural network model. An example method for performing beat-by-beat ventricular segmentation is described by Ouyang, D., He, B., Ghorbani, A. et al. in “Video-based AI for beat-to-beat assessment of cardiac function” published in Nature 580, 252-256 (2020), the content of which is incorporated by reference herein in its entirety.

The model 200 may be stored in a memory of a processing system, such the echocardiogram processing system 100 at FIG. 1. The neural network model 200 may receive as input, echocardiogram data of a patient, and output one or more of an LV segmentation and a blood pool segmentation. In one example, the echocardiogram data may be pre-processed prior to passing through the neural network model 200. Pre-processing echocardiogram waveform data may include filtering, for example. In some examples, filtering may be performed to remove very low quality video signals. In any case, pre-processing of the input echocardiogram frames may be based on the pre-processing operations performed during training the neural network model.

In some embodiments, the output of the model 200 may be fed into a second video-based CNN model, which outputs myocardial strain measurement.

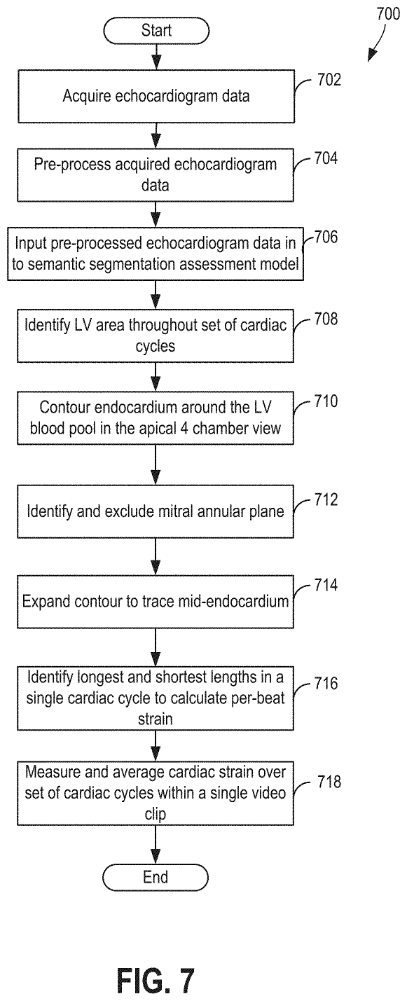

In some embodiments, a strain measurement algorithm may be implemented for measuring global longitudinal strain from the segmented frames. An example method for global strain measurement is shown at FIG. 7, which includes a high-level flowchart illustrating an example method 700 for performing global strain measurement. The method 700 may be executed by a processor, such as processor 104.

At step 702, the method 700 includes acquiring echocardiogram video data. Next, at step 704, the method 700 includes pre-processing the acquired data. At step 706, the pre-processed or raw video data may be input into a semantic segmentation model. At step 708, the method 700 includes generating left ventricular area measurements throughout a set of cardiac cycles. Additionally, blood pool segmentation may be generated. Next, at step 710, the method includes indicating a contour of the endocardium layer around the left ventricular blood pool. At step 712, the method 700 includes identifying and excluding the mitral annular plane. Next, at step 714, the method 700 includes expanding the contour to trace the mid-endocardium layer. At step 716, the method 700 includes calculating a per beat strain based on lengths measured in a cardiac cycle. At step 718, an average cardiac strain may be calculated over a set of cardiac cycle using a single video clip.

Strain Measurement Algorithm

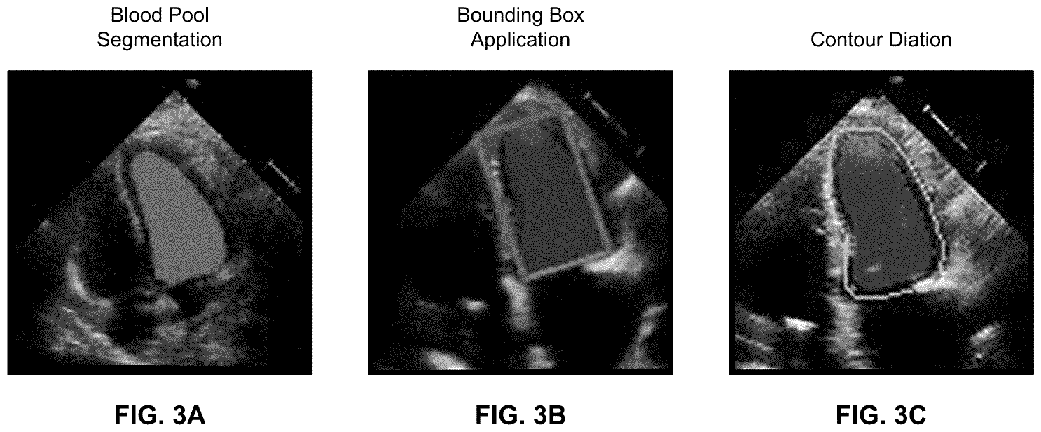

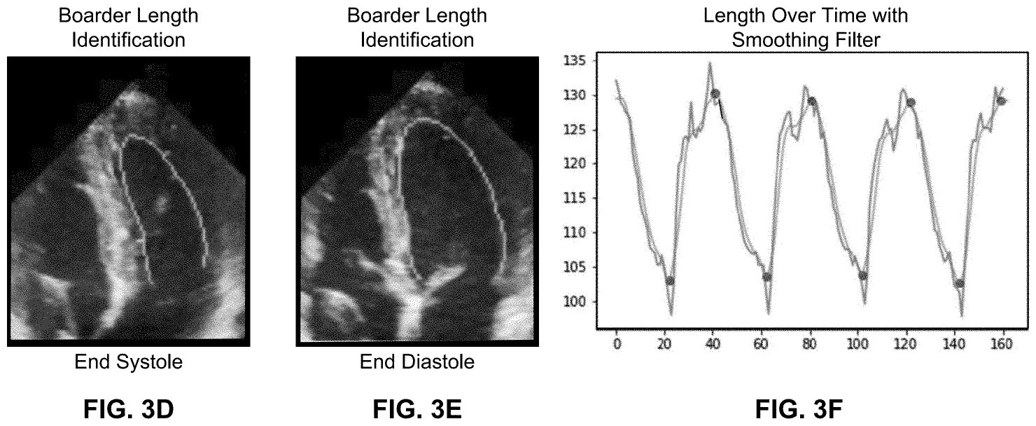

The strain algorithm may receive input from a semantic segmentation model which identifies the left ventricular area throughout the cardiac cycle. From the identification of the left ventricle, the algorithm calculates longitudinal strain using input echocardiogram videos by systematically: 1) contouring the endocardium layer around the LV blood pool in the apical 4 chamber view, 2) identifying and excluding the mitral annular plane, 3) expanding the contour to trace the mid-endocardium layer, 4) measuring the length of the LV each frame, 5) identifying the longest and shortest lengths in a single cardiac cycle to calculate per-beat strain, and 6) measuring and averaging the cardiac strain over all of the cardiac cycles within a single video clip (FIGS. 3A-3F).

The development of the semantic segmentation model have been previously described. Starting with the trained Echonet-Dynamic segmentation model weights, the left ventricular blood pool contour may be identified. To exclude the mitral annular plane from the length of the LV endocardium layer, a bounding box applied over the blood pool contour identified the insertion points of the mitral leaflets, and excluded the length of contour crossing the annular plane. Given that the exact boundary of the LV may have variability due to presence of trabeculations, varying degrees of dilation of the border and the effect on reproducibility was tested. Three-pixel dilation was chosen given the lowest standard deviation in strain measurement. The longitudinal length of this border contour was identified for each frame. Using Python's SciPy function scipy.signal.find_peaks, over a 32-frame sliding window, the maximum and minimum lengths of the LV endocardial tracing, corresponding with systole and diastole was identified. Given the expected smooth contraction and relaxation of the LV, a filter may be applied to the length by frame plot to reduce frame-to-frame variance in length across a cardiac cycle. The filter may be one or more of Savitzky-Golay (Savgol), convolve average, moving average, high pass and low pass. The Savgol filter resulted in measurements with the lowest standard deviation and was selected for the final pipeline. All algorithms were implemented in Python v3.9.5 using open-source libraries including PyTorch, SciPy, Torchvision, and OpenCV.

### EXAMPLES

The following examples are provided to better illustrate the claimed invention and are not intended to be interpreted as limiting the scope of the invention. To the extent that specific materials or steps are mentioned, it is merely for purposes of illustration and is not intended to limit the invention. One skilled in the art may develop equivalent trials, means or reactants without the exercise of inventive capacity and without departing from the scope of the invention.

Study Design

An echocardiography deep-learning based segmentation network, was used to identify the endocardial-blood pool interface across the cardiac cycle using apical 4-chamber (A4C) views. Strain was extracted using an automated pipeline based on mathematical analysis of the boundaries of the left ventricle across the cardiac cycle. The strain methodology was applied retrospectively over a large 3D echocardiography database with measurement of left ventricular GLS to assess for agreement. The strain methodology was then prospectively compared to standard 2D speckle tracking strain with repeated within-patient measurements from two sonographers using two separate echocardiography vendors to identify inter- and intra-measurement variability. The study was approved by Stanford University, Semmelweis University (#190/2020), and Cedars Sinai Institutional Review Boards.

Data Sets

The original segmentation model was trained on 7465 unique patients from Stanford Healthcare with expert annotation of ventricular areas in the A4C view and validated on an additional 2,565 videos. The DLS algorithm was then tested on an external cohort of on 970 unique patients with 2774 A4C videos from Semmelweis University. To compare intra-provider variation of our deep learning strain with conventional strain algorithms, 43 unique patients were prospectively scanned four times per patient by two experienced sonographers on two different vendor machines.

Deep Learning Strain Algorithm

The deep learning strain algorithm used a semantic segmentation model to identify the left ventricular area throughout the cardiac cycle. From the identification of the left ventricle, the algorithm calculates longitudinal strain using input echocardiogram videos by systematically: 1) contour the endocardium layer around the LV blood pool in the apical 4 chamber view, 2) identify and exclude the mitral annular plane, 3) expand the contour to trace the mid-endocardium layer, 4) measure the length of the LV each frame, 5) identify the longest and shortest lengths in a single cardiac cycle to calculate per-beat strain, and 6) measure and average the cardiac strain over all of the cardiac cycles within a single video clip (FIGS. 3A-3F).

The development of the original semantic segmentation model have been previously described. Starting with the trained Echonet-Dynamic segmentation model weights, we were able to identify the left ventricular blood pool contour. To exclude the mitral annular plane from the length of the LV endocardium layer, a bounding box applied over the blood pool contour identified the insertion points of the mitral leaflets, and excluded the length of contour crossing the annular plane. Given that the exact boundary of the LV may have variability due to presence of trabeculations, we tested varying degrees of dilation of the border and the effect on reproducibility. Three-pixel dilation was chosen given the lowest standard deviation in strain measurement. The longitudinal length of this border contour was identified for each frame. Using Python's SciPy function scipy.signal.find_peaks, over a 32-frame sliding window, we identified the maximum and minimum lengths of the LV endocardial tracing, corresponding with systole an diastole. Given the expected smooth contraction and relaxation of the LV, we tested multiple filters on the length by frame plot to reduce frame-to-frame variance in length across a cardiac cycle. We assessed multiple filters including Savitzky-Golay (Savgol), convolve average, moving average, high pass and low pass. The Savgol filter resulted in measurements with the lowest standard deviation and was selected for the final pipeline. All algorithms were implemented in Python v3.9.5 using open-source libraries including PyTorch, SciPy, Torchvision, and OpenCV.

External Validation on Cohort from Separate Healthcare System

The strain pipeline was applied to an external dataset of subjects underwent clinically-indicated 2D and also 3D echocardiography at Semmelweis University between November 2013 and March 2021. The cohort consisted of patients with different cardiac diseases (heart failure, cardiomyopathies, valvular heart diseases, etc.), healthy subjects with no cardiovascular risk factors and established cardiac diseases, and athletes. This external dataset includes A4C videos and 3D echocardiography-derived expert annotations using a variety of Philips and GE ultrasound machines, with GLS measurement through a computer workstation-based workflow (4D LV-Analysis 3, TomTec Imaging GmbH, Unterschleissheim, Germany). Cases were individually assessed for Turing test failure through identification of clear anatomically erroneous segmentation, and cases with failure were excluded from analysis.

Prospective Repeated Measures Analysis

The strain pipeline was prospectively compared with standard acquisition in 55 unique patients who received blinded, independent strain analysis by two senior sonographers who independently scanned, analyzed, and interpreted strain across two different machines. The two senior sonographers each had advanced cardiac certification and more than 15 years of experience each, and independently acquired images on each patient on the same day. Every patient was scanned using Epiq 7C (strain in v2.01) ultrasound machines as well as the GE Vivid E95 (strain in QLAB v10.2) ultrasound machine for a total of at least 4 acquisitions per patient, with strain performed using in-line software.

Statistical Analysis

The primary exposure was method of GLS measurement. The primary outcomes were agreement in strain between and within measurement modalities. Within our repeated measures cohort, we compared between and within readers, vendors, cycle-to-cycle variation in the DLS method, and manual versus deep learning strain. Within the external validation cohort, we compared between standard GLS and DLS. Comparisons were made using two-tailed paired T-test, intraclass correlation coefficient (ICC) and Bland Altman analyses. Analyses were performed using R v4.1.1.

Results

The original training cohort included 7465 patients (mean age 70±22 years old, 49% women, Table 1) with the repeated measures cohort including 43 patients (mean age 55±17 years, 38% women).

Demographic, Clinical and Echocardiographic Characteristics of the Training and External Validation Datasets

TABLE 1

| | Original | External |
|---|---|---|
| | training | validation |
| | dataset | dataset |
| Number of patients | 7,465 | 813 |
| Number of videos | 7,465 | 2,454 |
| Age, years (SD) | 70 (22) | 46 (23) |
| Female, n (%) | 3,662 (49) | 298 (37) |
| Heart failure, n (%) | 2,113 (28) | 238 (29) |
| Diabetes mellitus, n (%) | 1,474 (20) | 109 (13) |
| Hypercholesterolemia, n (%) | 2,463 (22) | 224 (28) |
| Hypertension, n (%) | 2,912 (39) | 315 (39) |
| Renal disease, n (%) | 1,475 (20) | 112 (14) |
| Coronary artery disease, n (%) | 1,674 (22) | 103 (13) |
| End diastolic volume, mL (SD) | 91.0 (46.0) | 144.9 (58.7)* |
| End systolic volume, mL (SD) | 43.2 (36.1) | 71.6 (49.0)* |
| Ejection fraction, % (SD) | 55.7 (12.5) | 53.5 (12.3)* |
| Echocardiographic machine | | |
| Philips Epiq 7C, n (%) | 4,832 (65) | 340 (14) |
| Philips Epiq 7G, n (%) | 0 (0) | 580 (24) |
| Philips iE33, n (%) | 2,489 (33) | 99 (4) |
| Philips CX50, n (%) | 62 (1) | 0 (0) |
| Philips Epiq 5G, n (%) | 44 (1) | 0 (0) |
| GE Vivid E95, n (%) | 0 (0) | 1,424 (58) |
| Other, n (%) | 38 (1) | 11 (0) |

*measured with 3D echocardiography
SD-standard deviation

Pipeline Finalization

Two significant empirical decisions were taken in designing the automated pipeline: the degree of dilation and the smoothing filter. For dilation, dilation of 3 pixels was compared to 5 pixels, as well as no dilation. When dilated zero pixels, the mean standard deviation of strain was 2.57%, when dilated 3 pixels, it was 2.02%, and when dilated 5 pixels, it was 2.50%. For the smoothing filter, we compared the standard deviations of our predictions. Savgol was 1.35%, low-pass was 1.52%, convolve average was 1.40%, and moving average was 1.89%, and therefore Savgol with 3 pixel dilation was selected for the final pipeline.

External Agreement Validation

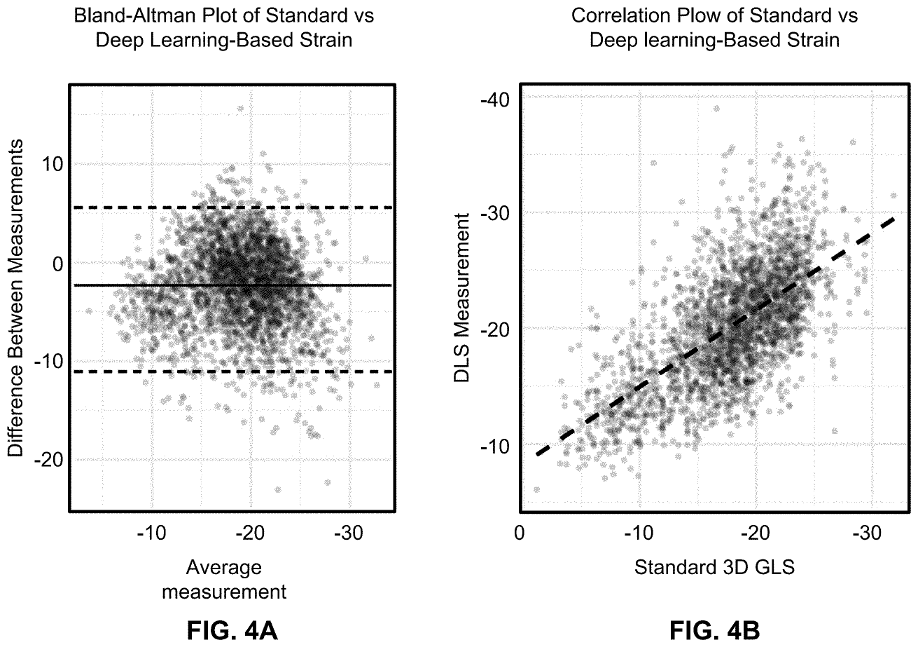

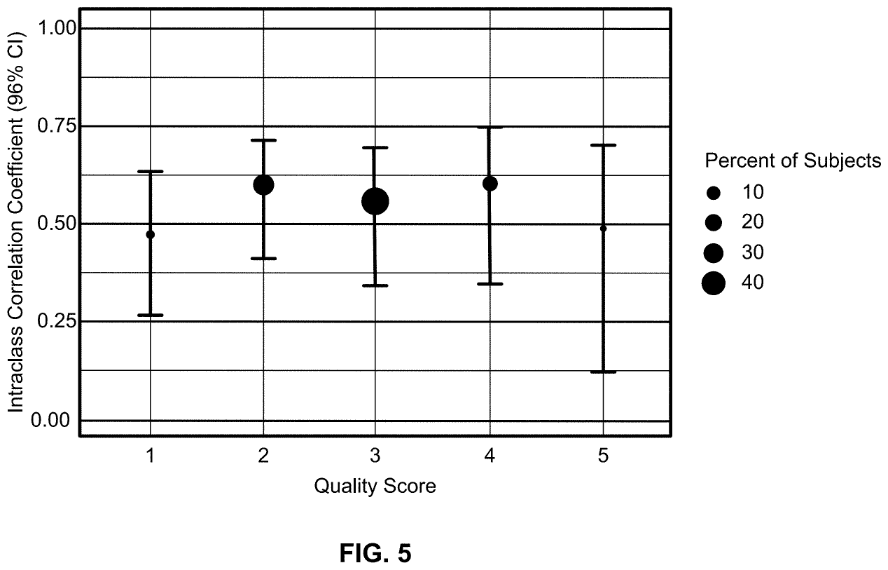

The external validation cohort consisted of 986 patients with 2949 studies. 3D echocardiography-derived GLS ranged from −1.16 to −31.83, with a mean of −17.31±5.13. The DLS method was able to be performed on 2774 (94%) studies in 970 patients (98%). The DLS ranged from −6.10 to −38.99, with a mean of −20.06±5.06. The ICC between the two measurements was 0.57 (0.37-0.69), p<0.001, with a bias of 2.31%, limits of agreement (LOA) of −6.01 to 10.64 (FIGS. 4A and 4B). The most significant predictors of absolute difference between 3D GLS and DLS were the DLS strain (β: −0.21, SE: 0.01, p<0.001), the 3D GLS (β: 0.15, SE: 0.01, p<0.001), the LV ejection fraction (β: −0.05, SE: 0.01, p<0.001), and the LV mass (β: 0.01, SE: 0.001, p<0.001). Subjective image quality graded on a 1-5 scale was not significantly associated with absolute difference in measures (β: −0.13, SE: 0.07, p=0.06) (FIG. 5).

Prospective Inter-Method Variation

In the inter-method repeated measures cohort, 43 patients received 4 manual measurements (two readers and two machines), with analyzable videos for DLS from both machines. The mean GLS measurement for reader 1 was −18.00±2.64% and reader 2 was −17.90±2.41. Measurements on Philips and GE had mean and standard deviations of −19.31±1.74% and −16.58±1.39%, respectively. The ICC between reader 1 and reader 2 was 0.63 (0.48-0.74) p<0.001. The ICC between GE and Philips systems was 0.29 (−0.01-0.53), p=0.03.

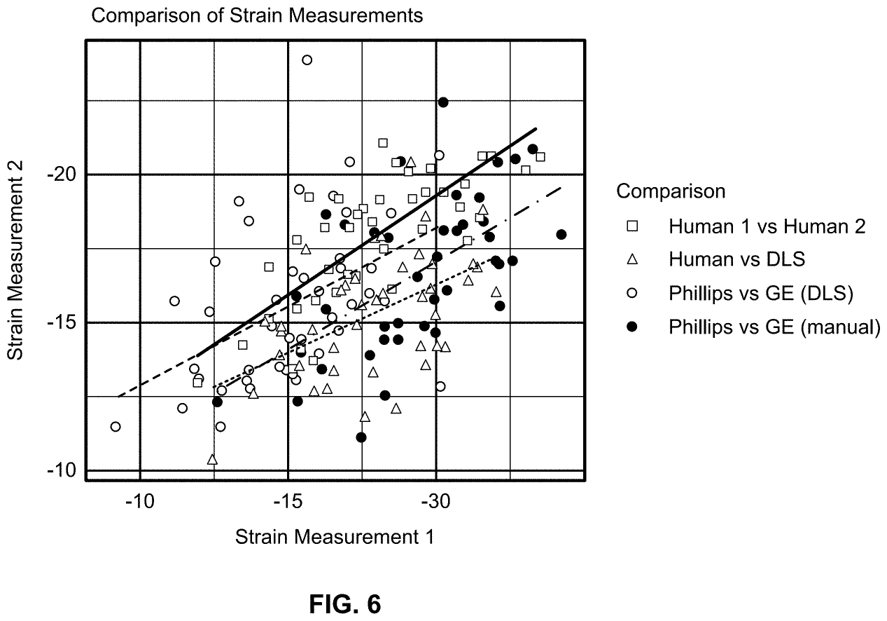

In the DLS measurements, the overall cohort had a strain of −15.28±1.35%, with Philips machine measurements having a mean and standard deviation of −14.96±1.42% and GE machine with −15.61±1.21%, with an ICC of 0.45 (0.18-0.66), p<0.001. Comparing the combined human versus DLS methods the mean strain was −17.91±2.55% for human and −15.29±1.35% for DLS. The ICC was not significant: 0.28 (−0.09-0.59), p=0.09, with a bias of 2.73%, LOA: −1.63 to 7.08% (FIG. 6).

Video clips of the DL strain method frequently have multiple cardiac cycles within a single acquisition. While standard clinical workflow does not necessitate multi-beat measurement, our DLS method can automatically produce strain measurements for all acquired cardiac cycles. Within the population, the mean number of cardiac cycles per video was 3.47, with a standard deviation of strain measurements of 1.7% and a mean difference in the maximum and minimum measurements of 2.6%.

Methods and systems described herein provide a vendor-agnostic, deep learning-based strain measurement compared to conventional GLS measurement for agreement within and between observers. On external cohort of patients with 3D echocardiography-derived GLS, our DLS performed consistently and within the variation seen between different commercial vendors. On a prospective cohort of patients undergoing repeated evaluation by different sonographers and different vendors, we see our DLS algorithm has lower variability compared to standard clinical variation by standard deviation, with decreased variation between vendors. Notably, between the human and DLS measurements, there was agreement, quantitatively similar to the degree of agreement between human measures on the two separate systems. Further, the method allows for beat-by-beat assessment of strain, our results demonstrate that there is moderate beat-to-beat variation in strain within a single acquisition, suggesting a lower bound in the precision of strain.

The reference range of different strain methods depends on each commercially available machine and its strain package, which can be limiting given the black-box nature of such strain packages. Our DLS algorithm produces comparable strains, within the reference range suggested by professional societies for normal patients and is fully automated, allowing for adaptation, iterative improvement, and easy establishment of normal ranges using local data. Given the lack of algorithmic transparency with speckle tracking packages, we show the DLS methodology has enhanced reproducibility, less variance between vendors, and has less dependence on image quality.

Previous literature has applied deep learning analyses in echocardiography and cardiac MRI for automated strain analysis. Salte et al. input echocardiographic images, passing them through classification networks for view and cardiac phase, then a segmentation network to define the myocardial space, then an optical flow network to assess strain. Given the application of optical flow, similar to speckle tracking, this technique will depend on high resolution and fidelity image quality. Deep learning approaches to semantic segmentation have been shown to be robust to even poor video quality, and could potentially measure strain in low quality clinical videos where speckle-tracking or optical flow fails. Early application in cardiac MRI for measurement of strain using deep learning in the UK Biobank has been shown. Given the dependence on feature tracking, MRI techniques to calculate strain is more similar to our semantic segmentation approach. While fundamental differences in methodology may explain the discrepancies between our method's results vs vendor-based GLS measurements, DLS may enable better comparison with CMR feature-tracking measurements.

In clinical practice, speckle-tracing algorithms often do not appropriately track the motion of the LV. The direct measurement and identification of the endocardial contour is both easily understandable and visually assessable for sources of error. Our algorithm enables rapid retrospective batch analysis of echocardiographic images, which may have applications in both the research and clinical workflow while eliminating human-based measurement variance. Additionally, this pipeline could also be adapted to other semantic segmentation models, allowing generalization to calculating right ventricular as well as atrial strain.

In this way, we present a deep-learning derived strain measurement based on a deep learning derived endocardial contour. The results show that this measurement can be performed reliably with low variance, and within the range of standard measurements. The DLS method is rapid, consistent, understandable, vendor-agnostic, and robust across a wide range of imaging qualities.

Computer & Hardware Implementation of Disclosure

It should initially be understood that the disclosure herein may be implemented with any type of hardware and/or software and may be a pre-programmed general purpose computing device. For example, the system may be implemented using a server, a personal computer, a portable computer, a thin client, a wearable device, a digital stethoscope, or any suitable device or devices. The disclosure and/or components thereof may be a single device at a single location, or multiple devices at a single, or multiple, locations that are connected together using any appropriate communication protocols over any communication medium such as electric cable, fiber optic cable, or in a wireless manner.

It should also be noted that the disclosure is illustrated and discussed herein as having a plurality of modules which perform particular functions. It should be understood that these modules are merely schematically illustrated based on their function for clarity purposes only, and do not necessary represent specific hardware or software. In this regard, these modules may be hardware and/or software implemented to substantially perform the particular functions discussed. Moreover, the modules may be combined together within the disclosure, or divided into additional modules based on the particular function desired. Thus, the disclosure should not be construed to limit the present invention, but merely be understood to illustrate one example implementation thereof.

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks), and any wireless networks.

Implementations of the subject matter and the operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on computer storage medium for execution by, or to control the operation of, data processing apparatus. Alternatively or in addition to, the program instructions can be encoded on an artificially-generated propagated signal, e.g., a machine-generated electrical, optical, or electromagnetic signal that is generated to encode information for transmission to suitable receiver apparatus for execution by a data processing apparatus. A computer storage medium can be, or can be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or can be included in, one or more separate physical components or media (e.g., multiple CDs, disks, flash memory, or other storage devices).

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, flash memory or optical disks. However, a computer need not have such devices. Moreover, a computer can be embedded in another device, e.g., a mobile telephone, a personal digital assistant (PDA), smart watch, smart glasses, patch, wearable devices, a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

### CONCLUSION

The various methods and techniques described above provide a number of ways to carry out the invention. Of course, it is to be understood that not necessarily all objectives or advantages described can be achieved in accordance with any particular embodiment described herein. Thus, for example, those skilled in the art will recognize that the methods can be performed in a manner that achieves or optimizes one advantage or group of advantages as taught herein without necessarily achieving other objectives or advantages as taught or suggested herein. A variety of alternatives are mentioned herein. It is to be understood that some embodiments specifically include one, another, or several features, while others specifically exclude one, another, or several features, while still others mitigate a particular feature by inclusion of one, another, or several advantageous features.

Furthermore, the skilled artisan will recognize the applicability of various features from different embodiments. Similarly, the various elements, features and steps discussed above, as well as other known equivalents for each such element, feature or step, can be employed in various combinations by one of ordinary skill in this art to perform methods in accordance with the principles described herein. Among the various elements, features, and steps some will be specifically included and others specifically excluded in diverse embodiments.

Although the application has been disclosed in the context of certain embodiments and examples, it will be understood by those skilled in the art that the embodiments of the application extend beyond the specifically disclosed embodiments to other alternative embodiments and/or uses and modifications and equivalents thereof.

In some embodiments, the terms “a” and “an” and “the” and similar references used in the context of describing a particular embodiment of the application (especially in the context of certain of the following claims) can be construed to cover both the singular and the plural. The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (for example, “such as”) provided with respect to certain embodiments herein is intended merely to better illuminate the application and does not pose a limitation on the scope of the application otherwise claimed. No language in the specification should be construed as indicating any non-claimed element essential to the practice of the application.

Certain embodiments of this application are described herein. Variations on those embodiments will become apparent to those of ordinary skill in the art upon reading the foregoing description. It is contemplated that skilled artisans can employ such variations as appropriate, and the application can be practiced otherwise than specifically described herein. Accordingly, many embodiments of this application include all modifications and equivalents of the subject matter recited in the claims appended hereto as permitted by applicable law. Moreover, any combination of the above-described elements in all possible variations thereof is encompassed by the application unless otherwise indicated herein or otherwise clearly contradicted by context.

Particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results.

All patents, patent applications, publications of patent applications, and other material, such as articles, books, specifications, publications, documents, things, and/or the like, referenced herein are hereby incorporated herein by this reference in their entirety for all purposes, excepting any prosecution file history associated with same, any of same that is inconsistent with or in conflict with the present document, or any of same that may have a limiting affect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the application disclosed herein are illustrative of the principles of the embodiments of the application. Other modifications that can be employed can be within the scope of the application. Thus, by way of example, but not of limitation, alternative configurations of the embodiments of the application can be utilized in accordance with the teachings herein. Accordingly, embodiments of the present application are not limited to that precisely as shown and described.

What is claimed is:

1. A method for myocardial strain measurement, the method comprising:
receiving an echocardiogram video comprising a plurality of echocardiogram frames acquired from an echocardiogram system;
segmenting left ventricle in each of the plurality of frames according to a neural network algorithm; and
determining an average measurement of global longitudinal strain (GLS) according to a strain measurement algorithm;
wherein the strain measurement algorithm is configured to evaluate change in length of left ventricle over a set of cardiac cycles in the echocardiogram video; and wherein the neural network is trained to segment one or more of a left ventricular area and a left ventricular (LV) blood pool.

2. The method of claim 1, wherein evaluating the change in length comprises identifying the LV blood pool and generating a contour of an endocardium layer surrounding the LV blood pool.

3. The method of claim 2, wherein evaluating the change in length comprises expanding the contour to a mid-endocardium layer.

4. The method of claim 2, wherein evaluating the change in length comprises measuring a border length of the left ventricle in each frame.

5. The method of claim 4, wherein the wherein the border length excludes a mitral annular plane.

6. A system for cardiac structure assessment, the system comprising:
at least one memory storing a trained neural network model and executable instructions;
at least one processor communicably coupled to the at least one memory and configured to execute the executable instructions to:
receive a set of echocardiogram frames of a patient from an echocardiogram system;
process the set of echocardiogram frames via the trained neural network model to output a set of segmented echocardiogram frames, wherein processing the set of echocardiogram frames to output a set of segmented echocardiogram frames comprises identifying one or more of a left ventricle and a left ventricle blood pool from the set of segmented echocardiogram frames;
determine an average myocardial strain measurement based on the set of segmented echocardiogram frames; and
display, via a display portion of a user interface coupled to the at least one processor, an indication of a border length for measurement of myocardial strain.

7. The system of claim 6, wherein the myocardial strain is determined on a frame-by-frame basis.

8. The system of claim 6, wherein the determination of the average myocardial strain measurement is performed based on the border length of the left ventricle, wherein the border length excluded the mitral valve plane.

9. The system of claim 6, wherein the determination of the average myocardial strain is based on a second neural network model trained according to a supervised learning algorithm using a plurality of labelled echocardiograms as a training dataset.

10. The system of claim 6, wherein the processor is further configured to apply a filter to compensate for frame-by-frame variations, the filter being selected from the group consisting of Savitzky-Golay (Savgol) filter, convolve average, moving average filter, high pass filter, and low pass filter.

11. The system of claim 6, wherein the average myocardial strain is based on a set of cardiac cycles.

12. The system of claim 6, wherein the average myocardial strain is based on an average global longitudinal strain measurement.

13. The system of claim 12, wherein the processor stores further instructions for determining, based on the average global longitudinal strain measurement, a heart failure condition, a left ventricular ejection fraction, a presence of a myocardial infarction, a chemotherapy cardiotoxicity, an amyloid cardiomyopathy, or any combination thereof.

14. A system for cardiac structure assessment, the system comprising:
at least one memory storing a trained neural network model and executable instructions;
at least one processor communicably coupled to the at least one memory and configured to execute the executable instructions to:
receive a set of echocardiogram frames of a patient from an echocardiogram system;
process the set of echocardiogram frames via the trained neural network model to output a set of segmented echocardiogram frames, wherein processing the set of echocardiogram frames to output a set of segmented echocardiogram frames comprises segmenting one or more heart chambers;
determine an average myocardial strain measurement based on the set of segmented echocardiogram frames; and
display, via a display portion of a user interface coupled to the at least one processor, an indication of a border length for measurement of myocardial strain.

15. The system of claim 14, wherein the one or more heart chambers includes a left ventricle, a right ventricle, a left atrium, a right atrium, or any combination thereof.

16. The system of claim 14, wherein the processor stores further instructions that when executed cause the processor to determine, based on the set of echocardiogram frames, a longitudinal strain, a radial strain, a circumferential strain, or any combination thereof.

17. The system of claim 14, wherein the processor stores further instructions that when executed cause the processor to determine a global longitudinal left ventricle strain based on the set of segmented echocardiograms.

18. The system of claim 17, wherein determining the global longitudinal strain comprises applying a Savgol filter to changes in left ventricular border length to reduce frame-by-frame variations.

19. The system of claim 14, wherein the processor stores further instruction that when executed cause the processor to apply a degree of dilation to a left ventricular endocardium boundary to exclude mitral annular plane.

20. The system of claim 19, wherein the degree of dilation is three pixels.
